(19) United States
(12) Patent Application Publication
(10) Pub. No.: US 2023/0137008 A1
(43) Pub. Date: May 4, 2023

(54) AUTHENTICATING SYSTEM FOR AUCTIONING PERISHABLE GOODS

(71) Applicant: Hungry Top Technologies Limited, Kolkata (IN)

(72) Inventors: Eman Kalyan Ghosh, Kolkata (IN); Devendra Tripathi, Union City, CA (US); Dev Dutta, Kolkata (IN); Amitava Roy Chowdhoury, Kolkata (IN)

(21) Appl. No.: 17/976,763

(22) Filed: Oct. 29, 2022

(30) Foreign Application Priority Data
Nov. 1, 2021 (IN) 202131050030

(51) Int. Cl. G06Q 30/08; G06Q 30/00; G06Q 10/08

(52) U.S. Cl. CPC G06Q 30/08; G06Q 30/018; G06Q 10/0832

(57) ABSTRACT

Disclosed herein is an authenticating system (150) for auctioning and delivering perishable goods. The system comprises a client tier (152) and a Service Provider (153); each having an electronic device (100) which is operably connected to a secure central cloud resident server (151) through Communication Network for performing auction and delivery activities of perishable goods. The system attaches an encrypted label containing quality attributes, food classification and preparation process to each auctioned item. The system performs batch scheduling of delivery with optimization of time and resource and identifies the closest delivery person (103). The consumer (101) accepts the delivery by decoding and verifying the encrypted label. The system ensures safe and authentic delivery of auctioned item. The system facilitates inventory for auctioning by allowing the transfer of portion of cooked food inventory into the auction inventory thereby reducing food wastage, attracting more customers, doing branding and social good.

### CROSS-REFERENCE TO RELATED APPLICATION(S)

This application claims priority to Indian Patent Application No. 202131050030, filed on Nov. 1, 2021, with the Indian Controller General of Patents, Designs & Trademarks, which is incorporated by reference herein in its entirety.

### FIELD OF THE INVENTION

The present invention relates to computing technology used in the food and beverages field and more particularly it is related to the auction and delivery of food and other such perishable goods.

### BACKGROUND

A perishable good is any product wherein quality of that product deteriorates due to environmental conditions with respect to time. An example of such a perishable good is food. Food being one of the basic necessities of humans, it is imperative to be concerned about the challenge to maintain quality and usage of food without its wastage.

In order to overcome such a challenge, many solutions have been tried so far. One such option is auctioning of food. An auction includes a system of buying and selling goods or services by offering them for bidding. The auction system allows people that are potential buyers to bid and the vendor to sell to the highest bidder. The bidders compete against each other, with each subsequent bid being higher than the previous bid. An auction is considered to be complete when the vendor accepts the highest bid offered and the buyer pays for the goods or services and takes possession of them.

The Indian published patent application 201641029264 discloses a device for food auction and delivery which enables the first user for such an auction. Also, there are current systems in the prior art published applications US2009099972 and CA2439214 that can auction food items and/or enable food sellers to auction the food. But there are challenges and limitations of these current systems from the aspect of efficient food delivery with quality and authenticity. The ubiquity of smartphones, emergence of tech savvy population and the COVID-19 pandemic have caused a shift in the method of how food travels from the kitchen to the customer's table. The food delivery has become an integral part of journey of food from vendor to the customer. Therefore, there is a pressing need of an integrated automated system to track the available food resources in the locality, conserve and be vigilant of food wastage.

The current businesses (also referred to as merchants, vendors, sellers, etc.) that produce perishable goods have twin challenge of maximizing customers and minimizing the waste of produced goods, all the while making sure that they remain profitable. To improve the margin, the merchants want to reach high end consumers, but those consumers are highly quality conscious and have specialized requirement like vegan food and non-allergic food. The requirements can be based on dietary restrictions in some cases. To improve rating and brand, the merchants want to provide good food, efficient delivery, and good customer experience. To be socially responsible corporates, the merchants also want to do social good by providing quality food at low price. To satisfy such dueling constraints is a technical challenge because the merchants have to rely appropriate automation.

### Technical Solution

Technical solutions are provided herein to address such technical challenges with providing an automation plan that satisfies dueling requirements of merchants of perishable goods. Embodiments of the technical solutions herein provide an auction platform that not only facilitates regular food ordering and delivery platform but also makes it a trustable and efficient food delivery system. Embodiments of the technical solutions described in the present disclosure mitigate the aforementioned drawbacks and limitations of existing systems by providing user-friendly, authenticable, and efficient auction and delivery platform for food and other perishable goods. The technical solutions herein are not limited only to the auctioned food items, but aspects of the technical solutions are also applicable for delivery of any non-auctioned perishable goods.

The foregoing objects of the technical solutions are accomplished, and the problems and shortcomings associated with the prior art techniques and approaches are overcome by the present technical solutions as described below.

Technical solutions described herein provide an authenticating and efficient auction and delivery platform for food and perishable goods.

Further, the technical solutions herein facilitate the auction platform to be a wastage avoidance tool by reducing the food and perishable goods wastage.

Further yet, the technical solutions herein facilitate to grow business with brand value and do social good by auctioning food at a discounted rate.

Further, the technical solutions herein bring the capability of authentication and reliability to the food auction platform.

Furthermore, technical solutions herein provide authenticable and reliable delivery platform for perishable goods.

### DEFINITIONS OF TERMINOLOGIES USED HEREIN

1. Consumer(s)/consumer(s): (101) Referring to FIG. 1
These are the people who bid or order for the food, drink or other perishable goods being offered by the Merchants. Typically, the consumers bid or order using their electronic device(s).

2. Merchant(s)/merchant(s): (102) Referring to FIG. 1
These are the representatives of the merchant who provide the food, drink, or other perishable goods to their consumers. These can be businesses, and other organizations. In some embodiments, a merchant can be represented by a computer server or other electronic device that facilitates receiving and servicing an order or bid from the consumer(s) 101.

3. Delivery Personnel/Person(s)/delivery personnel/person(s): (103) Referring to FIG. 1
These are the people who pick up the food delivery package from the Merchant and deliver the same to the Consumer. In some cases, the delivery personnel may be an autonomous robot.

4. Service Provider/service provider: (153) Referring to FIG. 1
These are the people who configure, monitor, and maintain various hardware and application components of the system (150).

5. Communication Network/communication network:
This includes any type of communication network like Local Area Network, Wide Area Network, Internet, Wireless, any other network and/or combination thereof.

### SUMMARY OF THE INVENTION

FIG. 1 depicts an authenticating system (150) for auctioning and delivering perishable goods' according to one or more embodiments disclosed herein. The said system (150) is an automated platform for a reliable, genuine, and efficient auction and delivery of food and perishable goods. Here, “genuine” indicates that the food item that was specifically bid upon is the one that is delivered to the consumer. As is described herein, the genuineness, or authenticity of that same specific food item being delivered is verified by generating an encrypted machine-readable label for the particular food item, which is decrypted by a consumer upon delivery of the food item. The encryption label, thus, provides a bona fide certificate that the delivered food item is the particular food item that was bid upon, where the bidding may depend on the particular ingredients and cooking process used for that food item.

Referring to FIG. 1, the said system (150) comprises a client tier (152) including consumers (101), Merchants (102), Delivery Personnel (103) and a service provider (153); each having an electronic device (100) either portable or non-portable as one of the embodiments. The said device (100) is operably connected through the Communication Network to a secure central cloud resident server (151) (“server”) comprising an application server (104) and a database server (105) for performing food and perishable goods related auction and delivery methods (such as those described herein). The portable electronic device (100) can be a smartphone, a laptop, a tablet, a notebook, or any other computing device or a combination thereof. The server (151) comprises an application server (104) and a database server (105). The application server (104) is communicatively coupled with the database server (105) which stores data and provides storage access. In an embodiment, the server (151) is accessed through a computer program product, such as a web portal, electronic device application (also referred popularly to as “app”), web browser, etc. or a combination thereof. The server (151) can be accessed by any one of the consumers (101), merchants (102), delivery personnel (103), and service providers (153). Accessing the server (151), or other features provided by the system (150) (for example, via the electronic device 100) can be referred to herein as accessing the system.

The consumer (101) logs into the system (150) with respective login credentials by using his/her electronic device (100). Multiple consumers (101) may login to the system (150) simultaneously. Once logged in, a consumer (101) can search for available bidding opportunities for a food of their interest and start bidding. The bidding process is a time bound process. The system (150) accepts these bids and displays the winning bid after expiry of the bidding time. There is one winning bid for one food item under auction. The said system (150) provides the consumer (101) with the detailed and specific information of the food item in the bid. The details of food may include food style, geographical origin, ingredients, information related to health and metabolic impact along with the food preparation process. The food preparation process is different for vegetarian recipe and non-vegetarian recipe having specific style of cooking. Such an aspect related to quality of the perishable goods is addressed by creating an encrypted label for an auctioned food and/or perishable goods. Labelling of food item facilitates tracking quality and food classification through the chain of linked information. The label carries all the above-mentioned information about food item and preparation process in an encrypted form. The label can be generated in a predetermined format like quick response (QR) code, barcode, or any other machine-readable format.

After winning the bid, a consumer makes the payment which is a secure and safe process made available by the system (150). The system (150) sends notifications to the respective merchants (102) and any assigned delivery personnel (103) indicating the completion of the sale, and to initiate further steps. Both merchants (102) and delivery persons (103) access the system (150) using their respective electronic devices (100).

The merchants (102) generate encrypted labels for the food package being auctioned in the winning bid, for example, in a predetermined format like the QR code. The said system (150) performs batch scheduling and finds the appropriate delivery person (103) based on his/her physical location so as to optimize the travel time of the delivery person and maximize the number of deliveries that one person can perform in one trip. The delivery person (103) approaches the merchant (102) to pick up the delivery package(s) of the food. The food item is said to be delivered to the corresponding consumer (101) after it is accepted by that consumer (101) by decoding and verifying the said encrypted food label attached to the food item with the one indicated during bidding process.

Some embodiments of the present invention also facilitate transfer of inventory by allowing the transfer of portion of cooked food inventory into an “auction inventory” thereby avoiding food wastage, getting more customers, building brand, and doing social good.

Embodiments of the present invention address the technical challenges and limitations of prior art related to reliability, authenticity, and quality of food item being auctioned and delivered by way of providing an efficient and authenticating system (150) of auctioning and delivering the food item.

### BRIEF DESCRIPTION OF THE DRAWINGS

These and other advantages are more readily understood by referring to the following detailed description disclosed hereinafter with reference to the accompanying drawing, definitions of terminologies used, and which are illustrated hereinafter.

The figures provided herein are not necessarily to the scale, in which:

FIG. 1: Illustrates the functionality of the authenticating efficient system (150) for auctioning and delivering perishable goods.

FIG. 2: Illustrates the main process flow of the system (150) with pre-bidding process (40).

FIG. 3: Illustrates a process flow of bidding method (50) to access the system (150).

FIG. 4: Illustrates a process flow (60) to provide detailed and specific information to the Consumers (101).

FIG. 5: Illustrates a process flow (70) to auto-select delivery personnel (103).

FIG. 6: Illustrates a process flow (80) to generate crypto labels for food item in auction by the Merchants (102).

FIG. 7: Illustrates a process flow (90) to verify and accept the delivery of food item being auctioned in the bidding process.

### DETAILED DESCRIPTION OF THE INVENTION

The features of the present invention and its technical advantages can be better understood from the following description of preferred embodiments together with the claims and accompanying schematic drawings. It is to be understood that this invention is not limited to the specific devices, methods, conditions, or parameters described and/or shown herein and that the terminology used herein is for the example only and is not intended to be limiting of the claimed invention.

Also, as used in the specification, the singular forms ‘a,’ ‘an,’ and ‘the’ include the plural, and references to a particular numerical value includes at least that particular value unless the content clearly directs otherwise. The pronouns “his,” “him,” “their” and/or similar refer to the noun unless the content clearly directs otherwise.

The nouns are not case sensitive unless noted otherwise. Ranges may be expressed herein as from ‘about’ or ‘approximately’ to another particular value. Also, it is to be understood that unless otherwise indicated, dimensions and material characteristics stated herein are by way of example rather than limitation and are for better understanding of sample embodiment of suitable utility, and variations outside of the stated values may also be within the scope of the invention depending upon the particular application. It is to be understood that the above description is intended to be illustrative, and not restrictive. The below discussed embodiments may be used in combination with each other. It will be apparent to those skilled in the art that the present invention may be practiced without these specific details.

It should be emphasized that the term “comprises/comprising” when used in this specification is taken to specify the presence of stated features, integers, steps, or components but does not preclude the presence or addition of one or more other features, integers, steps, components, or groups thereof. The terms and words used in the following description and claims are not limited to the bibliographical meanings, but are merely used to enable a clear and consistent understanding of the invention. Accordingly, it should be apparent to those skilled in the art that the following description of exemplary embodiments of the present invention are provided for illustration purpose only and not for the purpose of limiting the invention.

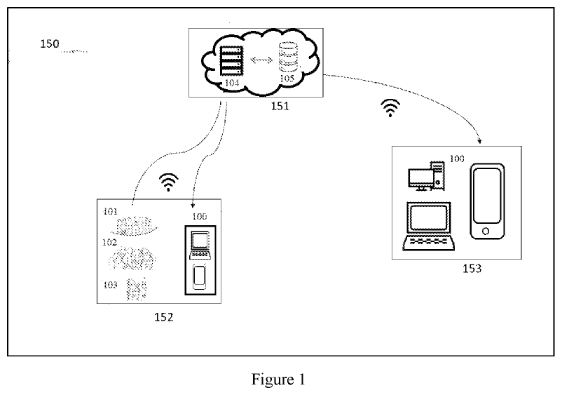

In accordance with the present invention, FIG. 1 illustrates an authenticating system (150) for auctioning and delivering perishable goods. The system (150) comprises a client tier (152) including consumers (101), merchants (102), delivery personnel (103) and a service provider (153); each having an electronic device (100). The electronic device (100) can be either portable or non-portable. The electronic device (100) can either be a smartphone, a laptop, a tablet, a notebook, a desktop, or any other communication-enabled computing device or a combination thereof. The said device (100) is operably connected to a secure central cloud resident server (151) (“server”) through a communication network. The server 151 executes one or more methods that include performing operations for food auction and delivery. The central cloud resident server (151) includes an application server (104) and a database server (105), among other components. The application server (104) is communicatively coupled to the database server (105), which stores data and provides storage access. In an embodiment, the system (150) is accessed by the client tier (152) through a computer program product, such as a web portal, an application (also referred popularly to as “app”), or the like, executing on the electronic device 100.

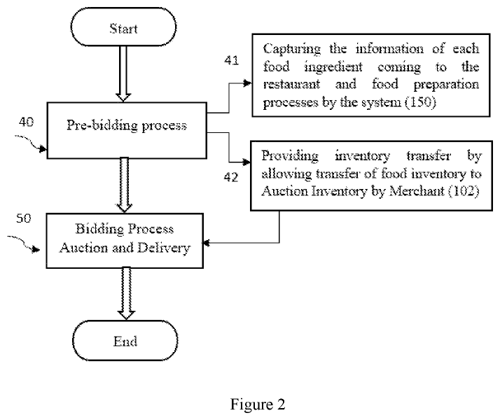

Referring now to FIG. 2, wherein the FIG. 2 illustrates the main process flow of the said system (150). The present invention provides the pre-bidding process (40) followed by the bidding process (50) for auctioning and delivering the perishable goods. The pre-bidding process (40) involves the step 41 in which the system (150) captures all the information of each and every food ingredient that comes to the restaurant. Here, “capturing” can include scanning of food ingredient label or food preparation label or other labels each describing one or more aspects of the food item. For example, the scanning can be performed using a device such as a camera, a code-scanner, etc. The labels that are scanned can include machine readable codes, such as barcode, quick-response code, etc. Alternatively, or in addition, the scanning can include capturing an image of a label that includes natural language (e.g., text), which is deciphered to recognize the ingredients of the food item. Other techniques may also be used to scan the information. When such labels are not available, capturing can include receiving input from the merchant (102), for example, using keyboard, voice, or any other such input formats or a combination thereof. The information captured can include information about the food ingredients as well as the cooking process, e.g., the recipe, particular durations of phases in the cooking, duration since the food item has been cooked, etc.

The captured food information is in the form of specific food classification (e.g., Vegetarian, Vegan, Jain, Halal and/or similar), quality attributes (e.g., type of ingredients like Organic and/or similar); specific geographic origin; metabolic impacts (e.g., Carbohydrates, Fats, Proteins, and/or similar) and other health impacts like calories and cholesterols. If such information is missing for any ingredient, then the merchant (102) enters this information and creates a label information for that food item or ingredient in the system (150). In addition to such food item information, the food preparation process which is different for vegetarian recipe and non-vegetarian recipe having specific style of cooking is also entered. Such an aspect related to quality of the perishable goods is addressed by creating the encrypted label for auctioned food and perishable goods. This food item information including information about its preparation process is managed by the system (150) and is further utilized to generate an encrypted label in the predetermined format like QR code if that food item is an auctioned item in the winning bid. Further at step 42, if the merchant (102) finds that there is more portion of cooked food items available in the regular food inventory, then he/she transfers those portions of food items to the auction food inventory of the system (150). In some embodiments, the transfer of food items to the auction food inventory is performed dynamically.

Further, in some embodiments, the transfer is performed in an automated manner. For example, the system (150) monitors the amount of food being cooked and consumed at a first merchant (102). The monitoring can be performed based on entries of the food items being registered in the database accessible by the system (150). The food items may be registered as the normal/regular food items, which are not yet in the auction inventory of the merchant (102). The system (150) can also monitor sale (i.e., consumption) of the food items at the first merchant (102). In some embodiments, if a food item has been in the normal/regular inventory for at least a threshold predetermined duration (e.g., one hour, three hours, one day, etc.), that food item may be automatically transferred into the auction inventory. Transferring to the auction inventory includes adding the food item to the list of food items that can be bid upon and enabling consumers to bid on the food item as described herein. The threshold predetermined duration can be dynamically adjusted by the system (150) depending on several factors including, ingredients, cooking process, first merchant, sale pattern, time of day, day of week, etc.

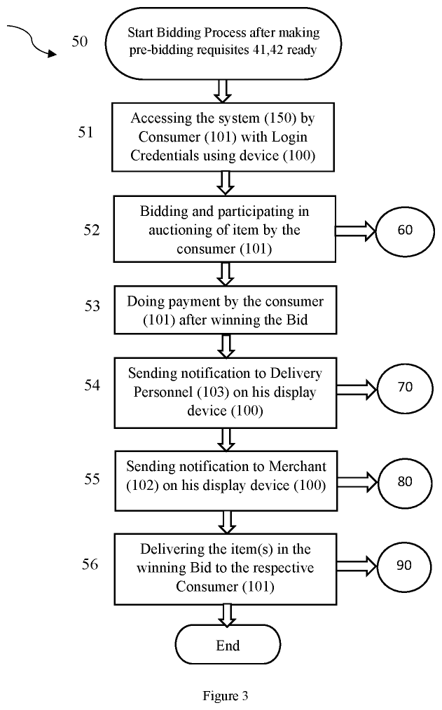

This auction food inventory is utilized for bidding of the food items. The results of the pre-bidding process are used as input to the Bidding process (50) as shown in FIG. 3.

Referring to FIG. 3, in another aspect, the present invention provides a method (50) for authenticated and efficient auctioning and delivering of perishable goods. Specifically, the bidding method (50) is described in conjunction with the system (150) of FIG. 1.

The bidding method (50) involves accessing the system (150) by any client tier (152) using the electronic device (100) with his/her login credentials as mentioned in step 51. If these login credentials are incorrect, the system (150) warns the end-user accordingly and does not allow the end-user to login. If the end-user is a new user, then he/she has to sign-up with information like name, location, address, category etc. The client tier (152) comprises the consumer(s) (101), the merchants (102) and delivery personnel (103). At a time, there can be multiple consumers who log into the system (150) with respective electronic devices (100). The client tier (152) successfully logs into the system (150) using the electronic devices (100).

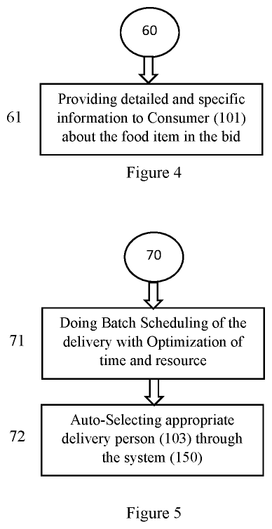

Referring to FIG. 3, at step 52, after successful login, the consumer (101) searches for the available bidding opportunities for a food item of his interest and participates in food auction. At Step 61 as shown in FIG. 4, while a consumer (101) takes part in such a bidding, he/she is provided with detailed information and specifications of a variety of food items. In an exemplary embodiment, the information is provided via a label information of each food item, where the label generated by the system (150) at step 41. Labelling involves creating and reading encrypted labels with specific food classification (e.g., Vegetarian, Vegan, Jain, Halal and/or similar), quality attributes (e.g., type of ingredients like Organic and/or similar); specific geographic origin; metabolic impacts (e.g., Carbohydrates, Fats, Proteins, and/or similar) and other health impacts like calories and cholesterols. These labels are created by using the information that comes with the ingredients which are used to make the food and related recipe. If such information is missing for any ingredient, then the merchant (102) enters this information and creates a label for that food item or ingredient in the system (150). Similarly, these labels contain the information about the food preparation process based on the style and type of food e.g., vegetarian, or non-vegetarian etc. Such an aspect related to quality of the perishable goods is included in the information used for creating the encrypted label for auctioned food and perishable goods. Every food item which is being auctioned, has such a food label which is generated dynamically by the system (150). The food label tracks quality and food classification through the chain of linked information.

Referring to FIG. 3 again, at Step 53, the system (150) tracks the winning bid. The information of winning bid is sent to all the consumers (101) who have logged into the system (150). This helps the consumers upgrade their bid. The bidding process of each auction is a time bound process and the remaining time available for each auction is displayed to the consumers on their respective devices (100). Once the time expires, the system (150) informs all the active consumers about the final winning bid(s). There can be more than one winning bid because more than one food item of the same type is available. At this time, the consumer makes the payment. The system (150) facilitates handling payment failures as well.

At step 54, the system (150) sends notifications to the delivery personnel (103) on his/her electronic device (100) using Batch scheduling of delivery. As shown in FIG. 5, at step 71, in an exemplary embodiment, the system (150) performs Batch Scheduling of the delivery with optimization of time and resource. At step 72, the system (150) selects an appropriate delivery person (103). Here the system (150) uses the physical location information of the merchants (102) and consumers (101) so that the food item being auctioned is delivered both in time-efficient and cost-effective manner. The system (150) finds the physical location of all bid-winners and those who have ordered food without bidding, physical location of food sources and present physical location of delivery resources. Using the nearest effective distance, the system (150) creates an ordered set per delivery person. The nearest effective distance is measured as time required to deliver food by a given delivery person (103) from a given food source i.e., the merchant (102) to a given customer meaning the consumer (101). Now the system (150) groups the orders such that delivery cost and delivery time is minimized. The delivery person (103) logs into the system (150) with his login credentials to view the notifications, delivery information and then approaches respective merchant (102) to collect the food item(s) to be delivered.

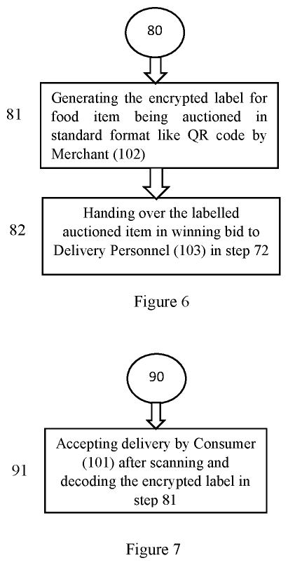

Similarly, at step 55 in FIG. 3, the system (150) sends notifications to the merchant (102) on his electronic device (100). The merchant (102) is the one from which/whom the consumer (101) is purchasing the goods, and from which/whom the delivery person (103) will pick up the goods. The notifications are viewed by the merchant (102) by logging into the system (150) with his/her login credentials. At step 81 as shown in FIG. 6, the merchant (102) generates the encrypted label for the food being auctioned, the encrypted label being in predetermined format like QR code. This encrypted label gets attached to the food item in the winning bid. At step 82, a package with this same food is handed over to the delivery person (103) selected in step 72 and who approaches the merchant (102) for collecting the delivery.

In FIG. 3, at step 56, the winning bid food item is delivered to the consumer (101). As shown in FIG. 7, at step 91, the consumer (101) accepts the delivery of the food item after scanning and decoding the encrypted label generated at step 81 that travels with the food package to be delivered. In another exemplary embodiment, the system (150) facilitates the consumer (101) to read and match the encrypted label. Such matching ensures the safe and authentic delivery of the food item that was promised in the bidding process. If there is a mismatch, then that food item may be returned, and issue resolved by taking requisite action. The decoding of the encrypted label includes the consumer (101) scanning the encrypted label, for example, using a machine-readable code, such as a barcode, a quick-response code, etc., that is included in the encrypted label. Alternatively, or in addition, the scanning can include capturing an image of the encrypted label and decoding the information in the encrypted label. In any of the cases (e.g., scanning machine readable code, capturing image, etc.), upon scanning the encrypted label, the information in the encrypted label is decrypted and compared with the information associated with the food item that the consumer (101) bid upon. The information is saved in the consumer's (101) account or order history. Only if the information from the order matches the decrypted information from the label, the consumer (101) is deemed to have received the genuine food item that he/she ordered. The encryption/decryption can be performed using one or more known techniques, such as public/private keys, etc.

Some embodiments of the present invention facilitate transferring inventory by allowing the transfer of portion of cooked food inventory into the auction inventory thereby avoiding food wastage, getting more customers, building brand, and doing social good as well. The merchant (102) may dynamically decide about how much more food is prepared and when this is to be transferred to the auction inventory. Eventually the system (150) includes the additional food to be auctioned, which is then handled as described herein.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The benefits and advantages which may be provided by the present invention, have been described above with regard to specific embodiments. These benefits and advantages, and any elements or limitations that may cause them to occur or to become more pronounced are not to be construed as critical, required, or essential features of any or all of the embodiments. The present invention is not limited only to the auctioned food items but also the innovative features of the present invention work for delivery of any non-auctioned perishable goods.

The foregoing descriptions of specific embodiments of the present invention have been presented for purposes of illustration and description. They are not intended to be exhaustive or to limit the present invention to the precise forms disclosed, and obviously many modifications and variations are possible in light of the above description. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

What is claimed is:

1. An authenticating system (150) for auctioning and delivering perishable goods, the system comprising:
a) an electronic device (100);
b) a secure central cloud resident server (151);
wherein
c) the electronic device (100) is operably connected to the secure central cloud resident server (151), and wherein the authenticating system is configured to perform a method for auctioning and delivering perishable goods, wherein the method comprises:
i. capturing information of food ingredients;
ii. transferring food inventory to auction food items;
iii. generating encrypted labels for the auctioned food items;
iv. receiving bids for the auctioned food items from a plurality of consumers;
v. scheduling a batch delivery of the auctioned food items;
vi. auto-selecting a delivery person; and
vii. delivering the auctioned food items to respective consumers;
d) the secure central cloud resident server (151) comprises an application server (104) and a database server (105) coupled with each other for communicating with the electronic device (100); and
e) the database server (105) is configured to update and store data and records of the bids and delivering activities of the auctioned food items.

2. The authenticating system (150) for auctioning and delivering perishable goods, as claimed in claim 1, wherein the system (150) captures the information (41) of each food ingredient in an auctioned food item, in the form of specific food classification, quality attributes, specific geographic origin, attributes related to metabolic impacts and other health impacts along with the food preparation process of the auctioned food item.

3. The authenticating system (150) for auctioning and delivering perishable goods, as claimed in claim 1, wherein the encrypted food label (81) is generated in a predetermined format including a machine-readable code.

4. The authenticating system (150) for auctioning and delivering perishable goods, as claimed in claim 1, wherein the system (150) scans and verifies (91) the said encrypted label integrated with the auctioned food items for ensuring authenticity of the auctioned food item delivered to the respective consumers (101) and for tracking quality of the auctioned food items.

5. The authenticating system (150) for auctioning and delivering perishable goods, as claimed in claim 1, wherein the transferring food inventory (42) comprises identifying a portion of cooked food as food inventory to be auctioned and for which bids are to be received.

6. The authenticating system (150) for auctioning and delivering perishable goods, as claimed in claim 1, wherein the system (150) performs the scheduling the batch delivery (71) of the auctioned food items comprises: finding the closest delivery person (103) based on physical locations of merchants (102) selling the auctioned food items and physical locations of consumers (101) for optimizing travel time and cost of delivery of the auctioned food items to the consumers (101).

7. A bidding method (50) for auctioning and delivering perishable goods, the bidding method comprising:
a) preparing, by a server, pre-bidding requisites by capturing information of each food ingredient (41) and food preparation processes of cooked food and transferring inventory of a portion of the cooked food to an auction inventory;
b) participating, by a consumer (101), in auctioning (52) of food items in the action inventory by bidding on a food item from the food items via an electronic device by logging into the server;
c) performing payment (53) for the food item, via the electronic device and the server, by the consumers (101), in response to winning a bid;
d) sending a first notification (54), by the server, to a delivery personnel (103) via a corresponding device (100) to deliver the food item to the consumer (101);
e) sending a second notification (55) to a merchant (102) on a corresponding device (100) to indicate the delivery personnel (103) selected to deliver the food item;
f) scheduling a batch delivery of the food item in the winning bid (56) in conjunction with other food items to respective consumers (101); and
g) marking the delivery of the food item to the consumer (101) after scanning and verifying an encrypted label including a machine-readable code (91), which is integrated with the food item.
